(19) United States
(12) Patent Application Publication
(10) Pub. No.: US 2007/0252305 A1
(43) Pub. Date: Nov. 1, 2007

(54) DOUBLE-INJECTION MOLDING METHOD

(75) Inventors: Nan-Hui Kuo, Taichung (TW); Chia-Meng Lai, Taichung (TW); Ying-Chieh Ting, Taichung (TW); Chi-Chao Lin, Taichung (TW)

Correspondence Address: PAI PATENT & TRADEMARK LAW FIRM, 1001 FOURTH AVENUE, SUITE 3200, SEATTLE, WA, 98154, US

(73) Assignee: TAIWAN GREEN POINT ENTERPRISES CO., LTD., Taichung (TW)

(21) Appl. No.: 11/689,093

(22) Filed: Mar. 21, 2007

(30) Foreign Application Priority Data
May 1, 2006 (TW) 95115495

(51) Int. Cl. B29C 45/16

(52) U.S. Cl. 264/255; 264/328.7; 264/328.8

(57) ABSTRACT

Double-injection molding methods through which the products do not have any parting lines between the molding materials comprise a mold, which has at least a male mold and a female mold. The male mold comprises at least one core. The female mold comprises at least one cavity and one core. The core of the male mold and the core of the female mold can be combined tightly. The male mold is stationary but the female mold is removable. The molding method of the present invention is to manufacture a product with two different plastic materials, where these two different plastic materials are injected into the mold in a specific order. And these two different plastic materials connect each other directly. After packing and cooling process, these two different plastic materials are shaped in the mold. A product with a smooth profile at the boundary of two materials is thus performed.

### RELATED APPLICATIONS

This application claims priority to Taiwan Application Serial Number 95115495, filed May 1, 2006, which is herein incorporated by reference.

### BACKGROUND

1. Field of Invention

The present invention relates to a double-injection molding method. More particularly, the present invention relates to a double-injection molding method through which the products do not have any parting lines between the molding materials.

2. Description of Related Art

Plastic moldings such as injection molding, extrusion molding, transfer molding, blow molding, compression molding, etc. are common methods in manufacturing plastic products. Injection molding has high molding efficiency, high yield and easy automation. Injection molding has been applied to manufacturing products with complicated sections, especially for manufacturing consumer electronics casings such as cell phone casings, computer casings, laptop casings, etc. Since the consumer electronics casings change with each passing day, variations of functions and applications have more and more variety. Therefore, profile design of consumer electronics casings plays a decisive role for consumers.

The application of double-injection molding is the most widely used in co-injection molding. Double-injection molding combines two different plastic materials to manufacture a product with different plastic materials, double-injection molding is the most widely method in manufacturing consumer electronics casings such as integrating the screen onto the shell of the cell phone to form the casing of the cell phone. The common method of double-injection molding is to pre-design a tolerance (ex. manufacturing tolerance or assembly tolerance, etc.) between two parts to make the product with different plastic materials be connected closely and precisely. Using the designed tolerance benefits to normalize the specifications, which can increase productivity and make the product with different plastic materials be assembled precisely. Designing the assembly tolerance makes the appearance of the product form notches that are called “fracture lines.” In order to have a beautiful appearance and shape, the notches produced by assembly tolerance are often quite small. However, the notches of consumer electronics casings will be dirty and clogged with contaminants after long-term use. The contaminants are not easy to be cleaned, and will influence the appearance.

Moreover, the notches produced by the tolerance will decrease the structural strength at the boundary of different plastic materials. Increasing the thickness of the different injected plastic materials at the boundary of the notches produces notches at the boundary of different plastic materials to achieve the demands of the structural strength. Therefore, the cost of the plastic materials of the products will increase and the profile design of the product will be limited (ex. thickness limitation).

### SUMMARY

An object of the present invention provides a double-injection molding method to improve the conventional double-injection molding, where notches are formed on the different plastic materials because of the assembly tolerance. An embodiment of the present invention does not need to design an assembly tolerance or manufacturing tolerance in the mold so that the notches at the boundary of different plastic materials are not formed. In addition, parting lines or boundary lines will not be produced between the different plastic materials.

Another object of the present invention is to provide a double-injection molding method with high productivity. Because an embodiment of the present invention does not need to consider the problems of manufacturing tolerance and assembly tolerance, the problems (ex. the quality problems of the mold combination, etc.) produced by the tolerance are directly avoided. Therefore, the method of a double-injection molding is conducive to promoting the productive efficiency.

Still another object of the present invention is to provide a double-injection molding method that increases the combinative strength of the products. Because the injection molding can make different plastic materials be connected tightly, the combinative strength at the boundary of different plastic materials is promoted efficiently. Therefore, the combinative strength of the whole product is increased.

Yet another object of the present invention is to provide a double-injection molding method that decreases the cost of the plastic materials of the products. In order to increase the structural strength of the notches between the boundaries of different plastic materials, the conventional double-injection molding increases the thickness of the plastic materials. However, the present invention efficiently promotes the combinative strength at the boundary of different plastic materials, so as to avoid increasing the thickness of the plastic materials. The quantities of the injected plastic materials are reduced so the cost of the plastic materials is decreased further.

A still further object of the present invention is to provide a double-injection molding method that increases flexibility of the profile design of the products. Because the present invention increases the combinative strength at the boundary of different plastic materials, the limitation of the combinative strength in the profile design of the products has been substantially reduced. Therefore, the flexibility of profile design is promoted.

Aforementioned objects in accordance with the present invention are to provide a double-injection molding method. The method of a double-injection molding includes providing a mold, which has at least a male mold and a female mold. The male mold is stationary but the female mold is removable. The female mold has at least one core and at least one cavity. When the male mold and the female mold are combined, the core of the male mold and the core of the female mold can combine closely together. The injection molding procedures are as follows, comprise:

Step 1: combining the stationary and the removable molds,

Step 2: molding a first plastic material,

Step 3: changing the female mold, and

Step 4: molding a second plastic material.

According to an embodiment of the present invention, a double-injection molding method is applied to manufacturing consumer electronics casings such as a cell phone casing, which comprises a cell phone shell and a cell phone screen. Because designing the tolerance on an injecting mold is not needed, the plastic materials of the cell phone shell and screen are connected tightly with each other. Not only are the durability and the strength of the cell phone casing increased, but also the thickness of the cell phone and the quantity of the plastic materials are decreased. The integrated profile of the entire cell phone casing makes the design of the cell phone casing more flexible to increase the competition of the products.

In addition, a double-injection molding method in accordance with the present invention does not need other manufacturing or assembling procedures, such as using adhesives to combine the shell and screen of the cell phone, after products are injected. Therefore, the manufacturing procedures can be shortened and the manufacturing speed and the yields can be increased.

### BRIEF DESCRIPTION OF THE DRAWINGS

These and other features, aspects, and advantages of the present invention will become better understood with regard to the following description, appended claims, and accompanying drawings where:

FIG. 1 is a sectional view of an embodiment of a mold in accordance with the present invention;

FIG. 2 is an elevation view of an embodiment of a mold in accordance with the present invention;

FIG. 3 is an illustration of an embodiment of procedures in accordance with the present invention;

FIG. 4 is an illustration of an embodiment of procedures in accordance with the present invention;

FIG. 5 is an elevation view of an embodiment of a product made by the method in accordance with the present invention;

FIG. 6 is a sectional view of the product in FIG. 5;

FIG. 7 is a sectional view of another product in FIG. 5;

FIG. 8 is a sectional view of still another product in FIG. 5;

FIG. 9A is a sectional view of another embodiment of a mold in accordance with the present invention;

FIG. 9B is an elevation view of another embodiment of a mold in accordance with the present invention;

FIG. 10A, FIG. 10B, FIG. 10C and FIG. 10D are illustrations of another embodiment of procedures in accordance with the present invention;

FIG. 11 is an elevation view of another embodiment of a product of a cell phone made by the method in accordance with the present invention; and

FIG. 12 is a sectional view of the product of a cell phone in FIG. 11.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

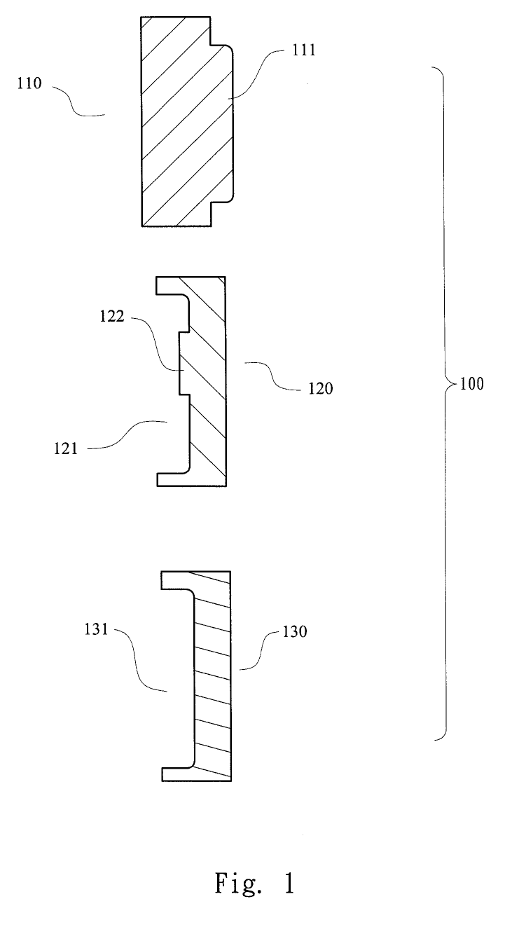

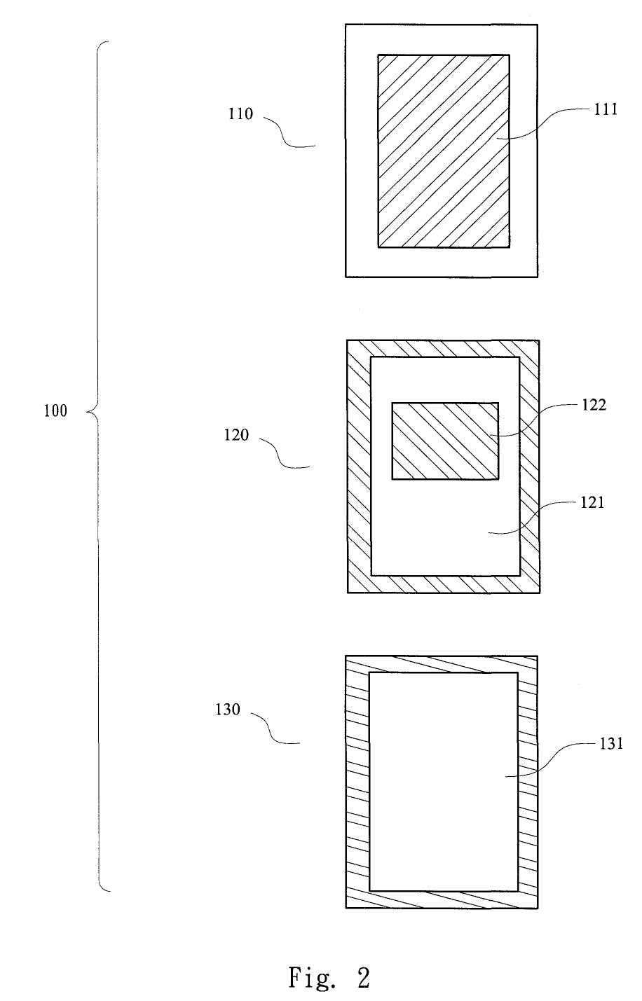

Refer to FIG. 1 and FIG. 2. FIG. 1 and FIG. 2 illustrate respectively a sectional view and an elevation view of a mold in accordance with the present invention. The mold 100 includes a male mold 110, a first female mold 120 and a second female mold 130. The male mold 110 has one or more than one male core 111 which can combine with the first female mold 120 and the second female mold 130 respectively. For conveniently illustrative purposes only, only one male core 111 is shown in FIG. 1.

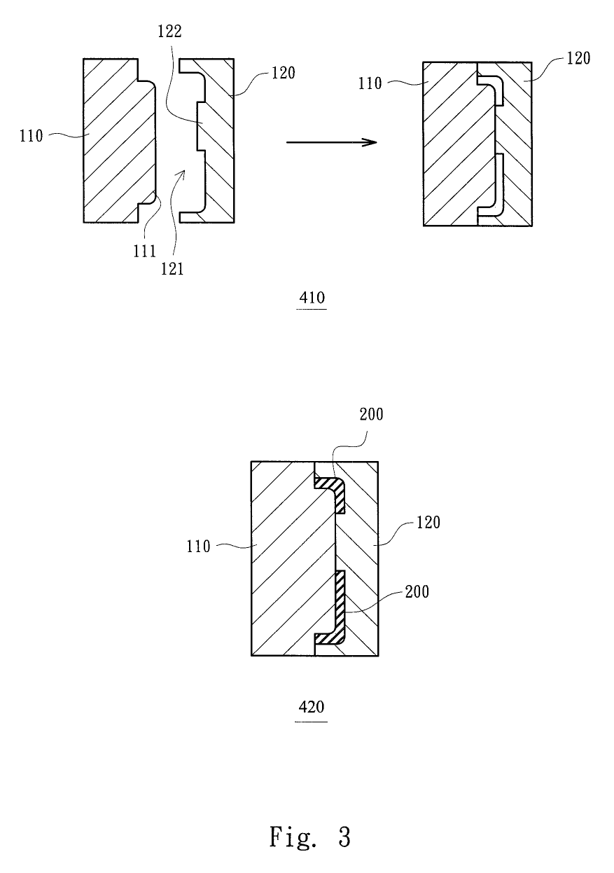

The first female mold 120 has a first cavity 121. The first cavity 121 has one or more than one female core 122. For conveniently illustrative purposes only, only one female core 122 is shown in FIG. 1. When the male mold 110 and the first female mold 120 are combined together, the male core 111 and the female core 122 are in tight contact. A space is formed between the first cavity 121 and the male core 111 to make a first plastic material 200 be injected and then molding (as shown in FIG. 3).

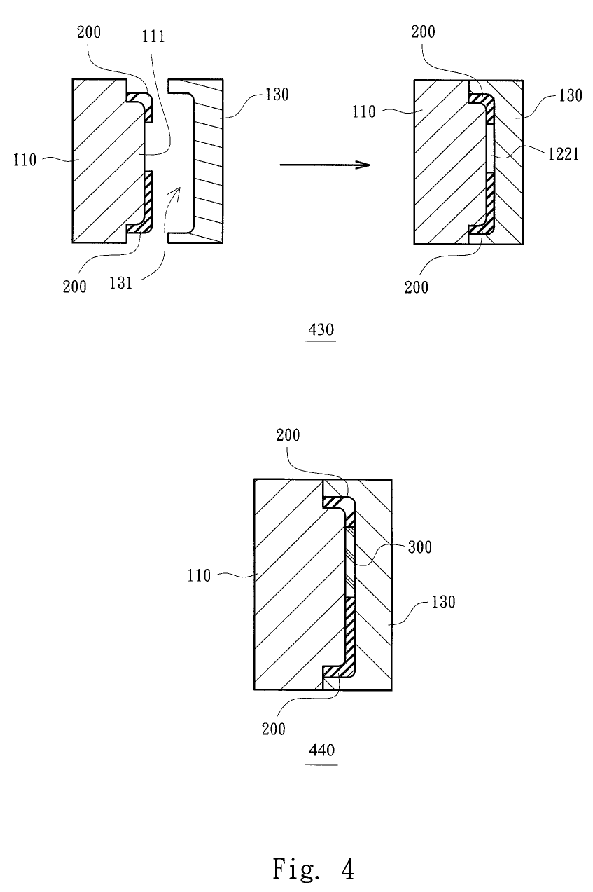

The second female mold 130 has a second cavity 131. When the male mold 110 and the second female mold 130 are combined together, a space is formed between the male core and the second cavity 131 to make a second plastic material 300 be injected and then molding (as shown in FIG. 4).

Refer to FIG. 3 and FIG. 4. The female core 122 is employed to form a mold cavity 1221 to be injected the second plastic material 300 inside. The mold cavity 1221 is a molding space to receive the second plastic material 300 and further makes the first plastic material 200 and the second plastic material 300 contact and combine directly in the mold 100.

The mold 100 in the embodiment has a male mold 110, a first female mold 120 and a second female mold 130. The male mold 110 is stationary, and the first female mold 120 and the second female mold 130 are removable. Both the first female mold 120 and the second female mold 130 can be exchanged to combine with the male mold 110. A first cavity 121 and a second cavity 131 can form a space with a different size. The space enables different plastic materials to be injected orderly into the mold 100. Refer to FIG. 3 and FIG. 4. FIG. 3 and FIG. 4 illustrate an embodiment of the method in accordance with the present invention, which comprises:

Step 1 (indicated by numeral 410), combining the stationary and the removable molds: combining the male mold 110 and the first female mold to connect the male core 111 of the male mold 110 and the female core 122 of the first female mold 120 tightly.

Step 2 (indicated by numeral 420), molding a first plastic material: after the male mold 110 and the first female mold 120 are brought into contact as described in step 1, a first plastic material 200 is injected into a first cavity 121, where the first plastic material achieves preliminary molding through packing and cooling process.

Step 3 (indicated by numeral 430), changing the female molds: after the first plastic material 200 is molded in the first cavity 121, the positions of the first female mold 120 and the second female mold 130 are exchanged, where the female core 122 is removed from the male core 111 so as to combine the second female mold 130 with the male mold 110.

In step 3, a mold cavity 1221 is formed because of the female core 122 of the first female mold 120. The mold cavity 1221 is employed to inject other plastic materials.

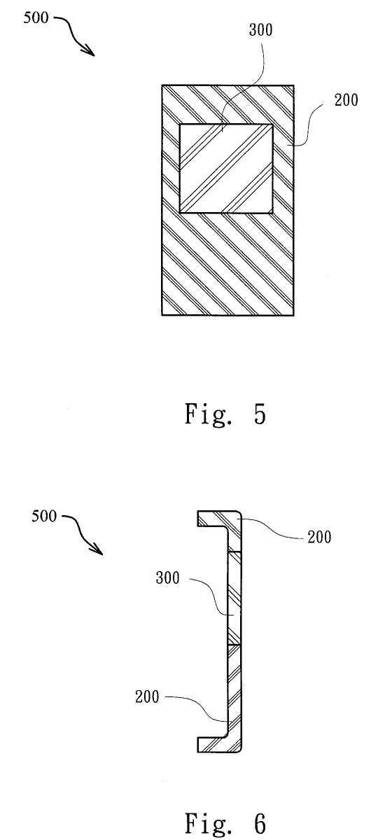

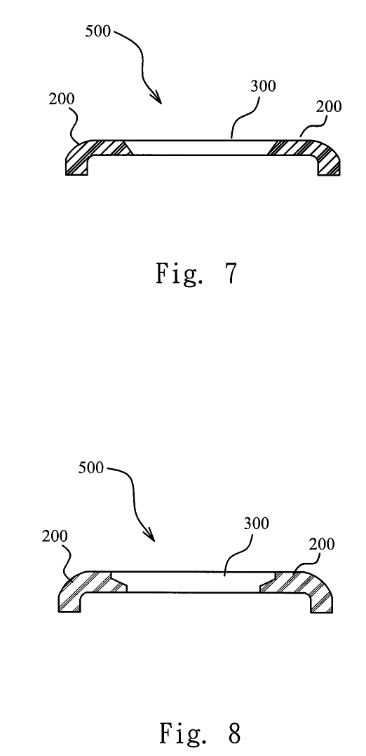

Step 4 (indicated by numeral 440), molding a second plastic material: injecting the second plastic material 300 into the mold cavity 1221. After the packing and cooling process has set the product, the product is formed and does not have any parting lines between the molding materials. (Ex. FIG. 5 and FIG. 6 illustrate an elevation view and a sectional view of a product 500 respectively.)

In step 4 above, the present invention does not use the conventional method which separates two materials to proceed double-injection molding procedures, so the second plastic material 300 can be in direct contact with the first plastic material 200 at a high temperature and in a fluid state. The contact state and condition of the first plastic material 200 and the second plastic material 300 can be improved. Therefore, the first plastic material 200 and the second plastic material 300 can be more tightly connected after packing, cooling and setting process so the combinative strength is increased.

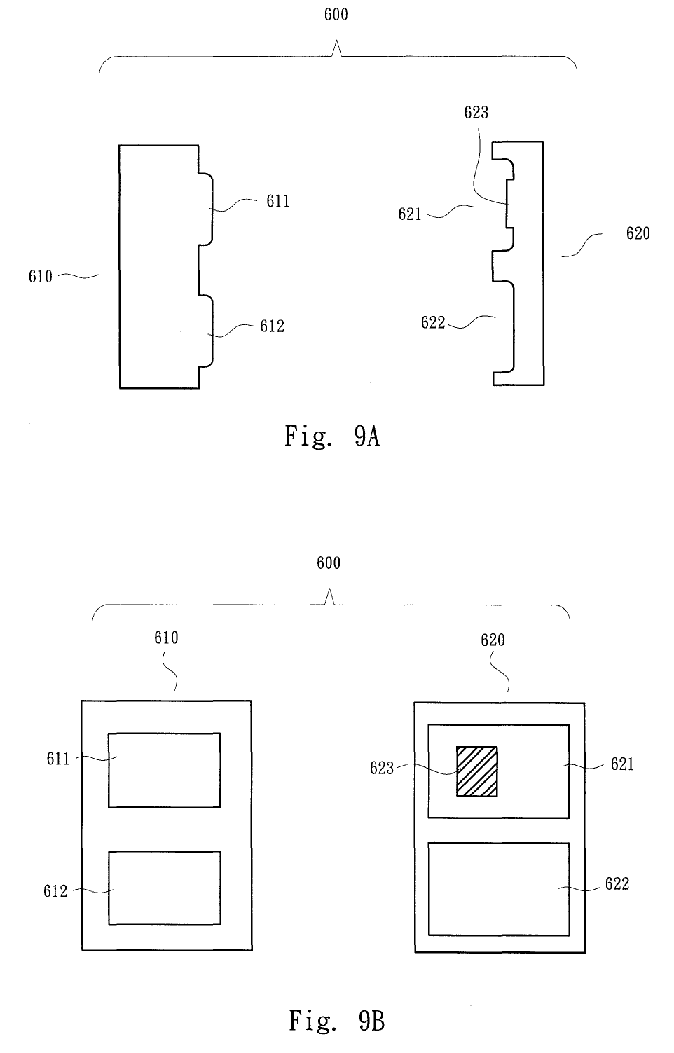

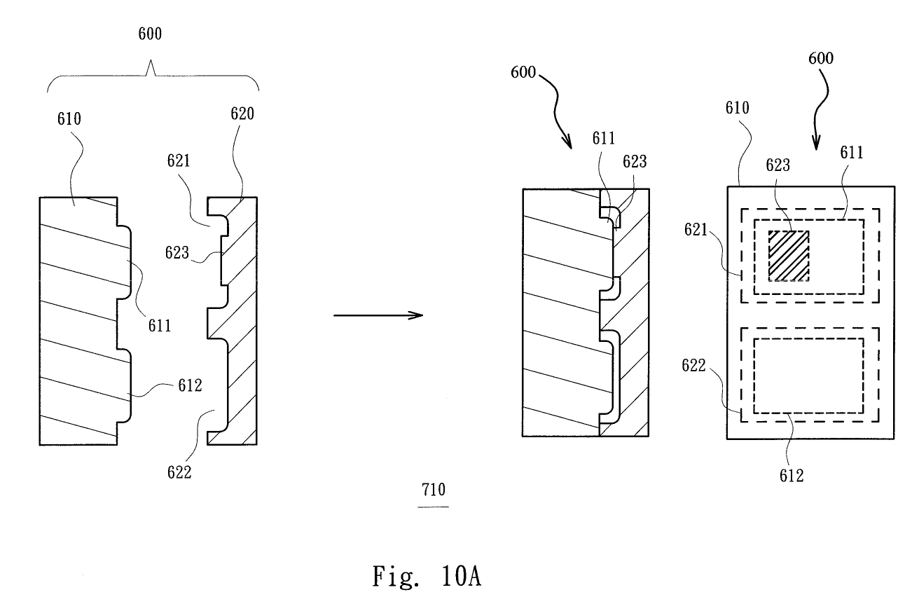

Among the embodiments in accordance with the present invention, the boundary of different plastic materials can have different contact surface shapes through designing different molds. Because different plastic materials are connected tightly, parting lines or boundary lines between different plastic materials do not appear and thereby improves the visual effect of the entire cell phone casing. Moreover, among the embodiments aforementioned in accordance with the present invention, the boundary of the product 500 can have a different contact surface shape between the first plastic material 200 and the second plastic material 300 through designing the mold 100. The combinative strength and structural strength between the different plastic materials are also increased. FIG. 7 illustrates a slant configuration of a contact surface of the different plastic materials. FIG. 8 illustrates a stair-step configuration of a contact surface of the different plastic materials.

According to another embodiment of the present invention, a combination of a mold 100 includes multiple male molds 110, multiple first female molds 120 and second female molds 130 in order to increase the productive efficiency and the yields.

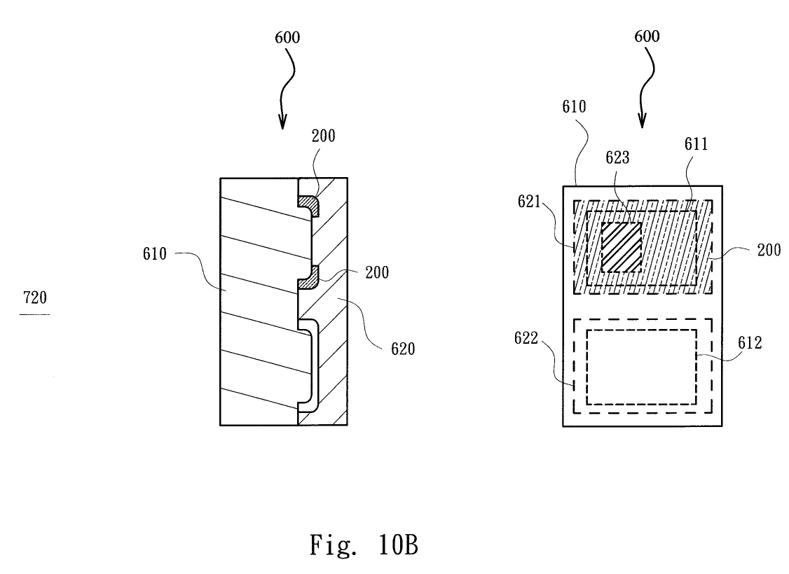

Refer to FIG. 9A and FIG. 9B. FIG. 9A and FIG. 9B illustrate an elevation view and a sectional view of a mold of another embodiment in accordance with the present invention. A mold 600 includes a male mold 610 and a female mold 620.

The male mold 610 is stationary and has a first core 611 and a second core 612. The female mold 620 is removable and has a first cavity 621, a second cavity 622 and a female core 623, which is set in the first cavity 621. The female core 623 combines tightly with the first core 611 or the second core 612 respectively.

Likewise, the female core 623 forms a mold cavity 6221 while the plastic material is molding. The mold cavity 6221 provides a molding space for the second plastic material 300 and further makes the first plastic material 200 and the second plastic material 300 contact and combine directly in the molding.

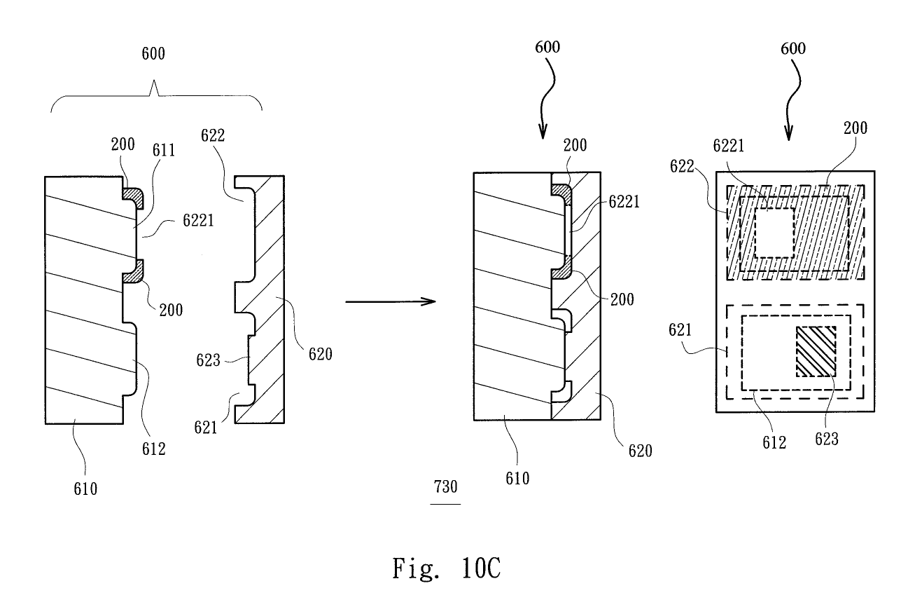

Refer to FIG. 10A, FIG. 10B, FIG. 10C and FIG. 10D. FIG. 10A, FIG. 10B, FIG. 10C and FIG. 10D illustrate implemented procedures of another embodiment in accordance with the present invention. The embodiment includes using the mold 600 to implement procedures. The implemented procedures include:

Step 1 (indicated by numeral 710), combining the stationary and the removable molds: combing the male mold 610 and the female mold 620 to connect the female core 623 in the first cavity 621 and the first core 611 tightly. FIG. 10A illustrates a sectional view and an elevation view of the mold.

Step 2 (indicated by numeral 720), molding a first plastic material 200: injecting the first plastic material 200 into the first cavity 621. The first plastic material 200 achieves preliminary molding through packing and cooling process. FIG. 10B illustrates a sectional view and an elevation view of the mold.

Step 3 (indicated by numeral 730), changing female molds: removing the female mold 620 to remove the female core 623 away from the first core 611 and then the female mold 620 is rotated 180 degrees to combine with the male mold 610. FIG. 10C illustrates a sectional view and an elevation view of the mold.

In step 3 above, the mold cavity 6221 is formed because of the female core 623. The mold cavity 1221 is employed to inject other plastic materials after the male mold and the female mold are combined together again.

Step 4 (indicated by numeral 740), molding a second plastic material 300: injecting the second plastic material 300 into the mold cavity 6221 and the first plastic material 200 into the first cavity 621 at the same time. In other words, the first cavity 621 and the second cavity 622 do injection molding at the same time respectively.

The second plastic material 300, which is injected into the second cavity 622, can directly connect to the first plastic materials 200 at a high temperature and in the fluid state. After packing, cooling and setting process, a product of the present invention is formed. FIG. 10D illustrates a sectional view and an elevation view of the mold.

The first plastic material 200 and the second plastic material 300 are molded in the female mold 620 at the same time respectively so the injecting tasks can be continued to only repeat the step 3 and the step 4. The manufacturing procedures are reduced and the productive efficiency is promoted so the method in accordance with the present invention is advantageous for mass production.

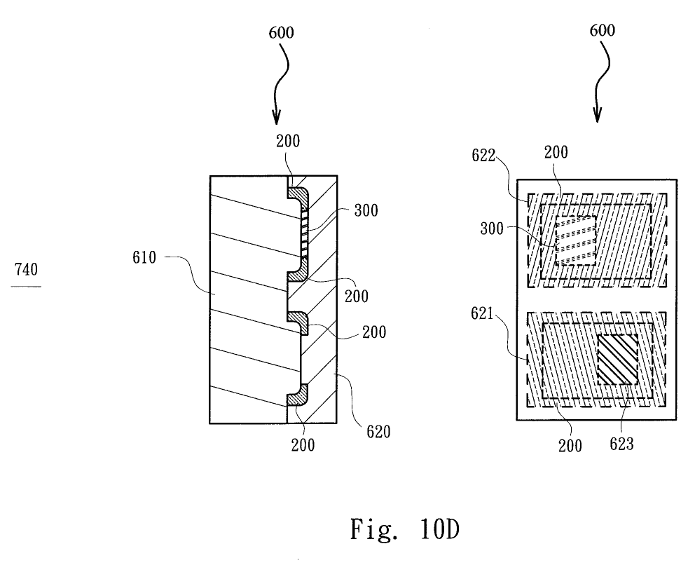

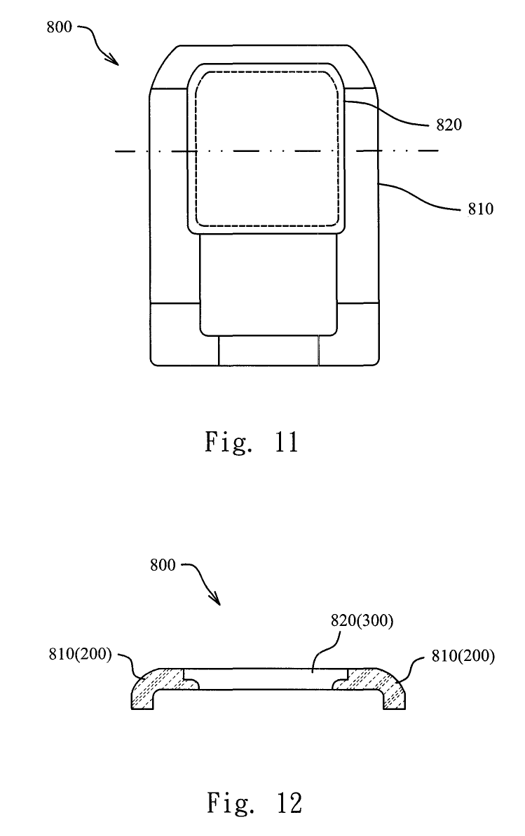

Refer to FIG. 11 and FIG. 12. FIG. 11 and FIG. 12 illustrate respectively an elevation view and a sectional view of a cell phone product made by the embodiments in accordance with the present invention. The product can be a cell phone casing 800 (consumer electronics casings) comprising a cell phone shell 810 and a cell phone screen 820. The present invention provides a method, which is effective to combine the cell phone shell 810 with the cell phone screen 820 tightly, in manufacturing a cell phone case 800. In the procedures of forming the cell phone casing 800 applying the present invention, the first plastic material 200 is the plastic materials of the cell phone shell 810 and the second plastic material 300 is the plastic materials of the cell phone screen 820.

The contact surface between the first plastic material 200 and the second plastic material 300 is a stair-step. The contact surface of the stair step can improve the structural strength between the cell phone shell 810 and the cell phone screen 820 after molding. In other words, the present invention increases the combinative strength between the molding materials and the structural strength of the product. Therefore, the present invention can make the profile design of the product structure have more flexible space when the product is designed the structural strength of the product considered. The present invention is suitable for being used in consumer electronic products, which emphasize the appearance.

According to the embodiments in this application, the present invention can make different plastic materials contact directly during the molding phase. Thus designing an assembly tolerance in the mold at the boundary of different plastic materials is not needed. Not only is the mold design simplified thereby but the efficiency of the pre-processing stage is also improved. In addition, because the contact surface has already been formed and connected tightly during the injection molding, the problems of the assembling work (shorten assembling wok procedures) and the production (ex. process faults cause the quality reduction) are avoided because of the tolerance. Therefore, the present invention is conducive to reducing design complexity, producing and assembly procedures, and the competitive positioning of the product is increased greatly.

Moreover, the present invention injects different plastic materials into the mold in an orderly manner during the injection molding. Then the late-injected plastic materials in the liquid state are combined with the early-injected plastic materials, which make the different plastic materials connect directly to each other in a high temperature state and achieve the effect of a tight connection after cooling and setting process. Thus the boundary of different plastic materials does not have any notches and prevents any parting lines from forming. The combinative strength between the different plastic materials is increased due to the area of the contact surface with the different plastic materials is increased.

The present invention not only makes the structure strength of the products be increased efficiently but also avoids the limitation of the profile design. Such as the present invention does not cause the damage on the structure strength of the product and reduces to use the quantities of the plastic materials so the cost of the plastic materials is reduced.

The advantages of the present embodiment include:

First, in the present invention it is not necessary to design the tolerance so the different plastic materials can be tightly connected and molded directly. The appearance of the products will not produce any parting lines.

Second, the present invention avoids the tolerance factor of the mold combination during the manufacturing so the productive efficiency can be increased.

Third, the present invention can directly connect different plastic materials together tightly so the combinative strength can be increased and then the whole structural strength can be promoted.

Fourth, the present invention can reduce the quantities of the plastic materials and also does not damage the structural strength of the product so the cost of the manufacturing is conducive to being reduced.

Fifth, the present invention has the advantages above to avoid causing limitations of the profile design because of structural strength considerations so the profile design is more flexible, the structural strength increased and the cost of the product reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A double-injection molding method comprising:
providing a mold, wherein the mold has a first male mold, a first female mold and a second female mold, the first male mold is stationary, and the first female mold and the second female mold are removable, the first male mold has a first male core, the first female mold has a first cavity and a first female core, the second female mold has a second cavity; and the method further comprising
Step 1, combining the stationary and the removable molds: combining the first male mold with the first female mold, and making the first male core and the first female core be connected tightly to finish combining the stationary and the removable molds;
Step 2, molding a first plastic material: injecting the first plastic material into the first cavity to mold the first plastic material;
Step 3, changing the female molds: removing the first female mold to remove the first female core from the first male core, and combining the second female mold with the first male mold tightly to form a mold cavity in the first plastic material to complete changing the female molds; and
Step 4, molding a second plastic material: injecting the second plastic material into the second cavity to mold the second plastic material to form a product.

2. The method as claimed in claim 1, wherein the mold has multiple second male molds combined with the first male mold.

3. The method as claimed in claim 1, wherein the first male mold has multiple second male cores.

4. The method as claimed in claim 2, wherein the multiple second male molds have multiple second male cores.

5. The method as claimed in claim 1, wherein the first female mold has multiple second cavities.

6. The method as claimed in claim 1, wherein the first female mold has multiple second female cores.

7. The method as claimed in claim 1, wherein the second female mold has multiple third cavities.

8. The method as claimed in claim 1, further comprises forming a contact surface between the first plastic material and the second plastic material of the product.

9. The method as claimed in claim 8, wherein the contact surface is a slant configuration.

10. The method as claimed in claim 8, wherein the contact surface is a stair-step configuration.

11. A double-injection molding method comprising:
providing a mold, wherein the mold has a male mold and a female mold, the male mold is stationary and the female mold is removable, the male mold has a first core and a second core, the female mold has a first cavity, a second cavity, and a female core is set in the first cavity; and the method further comprising
Step 1, combining the stationary and the removable molds: combining the male mold with the female mold, and making the female core and the first core be connected tightly to finish combining the stationary and the removable molds;
Step 2, molding a first plastic material: injecting the first plastic material into the first cavity to mold the first plastic material;
Step 3, changing female molds: removing the female core from the first core and exchanging the first cavity and the second cavity to form a mold cavity, combining the male mold with the female mold again to make the female core and the second core be connected tightly to change the female molds; and
Step 4, molding a second plastic material: injecting the second plastic material into the mold cavity to mold the second plastic material to form a product.

12. The method as claimed in claim 11, wherein the mold has multiple male molds.

13. The method as claimed in claim 11, wherein the male mold has multiple male cores.

14. The method as claimed in claim 12, wherein multiple male molds have multiple male cores.

15. The method as claimed in claim 11, wherein the female mold has multiple first cavities.

16. The method as claimed in claim 11, wherein the female mold has multiple female cores.

17. The method as claimed in claim 11, further comprises forming a contact surface between the first plastic material and the second plastic material of the product.

18. The method as claimed in claim 17, wherein the contact surface is a slant configuration.

19. The method as claimed in claim 17, wherein the contact surface is a stair-step configuration.
